(19) United States
(12) Patent Application Publication
(10) Pub. No.: US 2005/0143245 A1
(43) Pub. Date: Jun. 30, 2005

(54) Centrifuge especially a separator

(76) Inventors: Werner Kohlstette, Oelde (DE); Willi Niemerg, Oelde (DE); Thomas Kleimann, Oelde (DE)

Correspondence Address: BARNES & THORNBURG, 750-17TH STREET NW, SUITE 900, WASHINGTON, DC, 20006, US

(21) Appl. No.: 10/513,519

(22) PCT Filed: Apr. 25, 2003
(86) PCT No.: PCT/EP03/04291

(30) Foreign Application Priority Data
May 8, 2002 (DE) 10220757.7

(51) Int. Cl. B04B 1/14

(52) U.S. Cl. 494/41

(57) ABSTRACT

A centrifuge including a centrifugal drum that includes a centrifugal chamber and a centrifugal chamber bottom part displaceable relative to the centrifugal drum. Also included is a piston slide axially displaceably arranged to be in and/or on the centrifugal drum. At least one seal is arranged in a surrounding groove on an outer circumference of the centrifugal drum bottom part and further arranged between the piston slide and the outer circumference of the centrifugal chamber bottom part to seal off a gap between the piston slide and the centrifugal chamber bottom part.

The invention relates to a centrifuge, particularly a separator, according to the preamble of claim 1.

A separator of this type is known from German Patent Document DE 199 22 237 A1. The construction shown in this document, which can be operated, among other things, with cooled sterile air as the control and cleaning fluid, has been successful particularly in areas with high hygienic requirements. However, a demand for improvement still exists with respect to hygiene in the area of the seal(s) in the gap between the axially displaceable piston slide and the centrifugal chamber bottom part and/or the centrifugal drum, in whose area deposits may occur. From German Patent Document DE 199 52 785 A1, a similar state of the art is known which results in similar problems although the seal is situated partially open in a gap.

Another state of the art is known from U.S. Patent Document U.S. Pat. No. 4,322,362. Here, a seal is arranged on the upper edge of a drum bottom part on a step of the lower drum part constructed on the inner circumference, outside the lower drum part, a piston slide being axially movable. The seal has an upper, relatively long, free section which rests on the inner circumference of the piston slide. From a sanitary point of view, this arrangement has little advantage because a gap exists below the seal in which deposits may form. The relatively expensive seal is, among other things, not suitable for high centrifugal forces, as can be reached by modern separators (up to 3,500 g or more), since there is the risk that such high compressions of the seal on the wall to the piston slide occur which impair its function.

It is known from German Patent Document DE 653 294 to arrange a membrane between a drum bottom part and an exterior pressure ring. German Patent Document DE 19087949 A teaches the arrangement of a seal in a groove of the drum top part outside the drum, where the initially described sanitary problems inside the drum play no role.

It is therefore an object of the invention to further develop the separator of the above-mentioned type such that the tendency to develop of contaminations and deposits particularly in the area of the above-mentioned seals is reduced.

The invention achieves this task by means of the object of claim 1. Accordingly, the groove, into which the at least one seal is inserted, is constructed to be axially open at least in sections toward the centrifugal chamber, and the at least one seal is situated to be axially open at least in sections toward the centrifugal chamber.

While the construction is simple, this solution constitutes a particularly good prevention of the formation of deposits. As a result of the cost-effective and constructively simple method, it can also be implemented that the centrifugal material flows around the seal and that, during the cleaning, the cleaning fluid flows around the seal, which, on the one hand, reduces the possibility that deposits may be formed and, on the other hand, permits the removal of possibly remaining contaminations on the seal as a result of the cleaning fluid. Nevertheless, in a simple manner, the seal is provided with a good hold in the groove. A complicated shaping of the seal is not required. On the contrary, it is sufficient to use simple and cost-effective O-rings as sealing rings, particularly also with an advantageous square cross-section.

Preferably, the element which can be displaced axially in and/or on the centrifugal drum is a piston slide and/or the component which is non-displaceable relative to the centrifugal drum—the centrifugal chamber bottom part (for example, arranged in a drum bottom part), so that it becomes possible to reduce the formation of deposits in the gap between these two elements.

It is advantageous for the groove to be arranged at the outer circumference of the centrifugal chamber bottom part and to preferably be constructed axially open in a surrounding manner with the exception of webs. In a simple fashion, the webs provide a good hold of the seals in the immobile centrifugal chamber bottom part. Particularly preferably, one of the webs respectively is shaped at preselected angular distances onto the centrifugal chamber bottom part, which secures the seal(s) against a falling out of the groove in the axial direction. The holding function is therefore limited to minimal constructive expenditures while the sanitary characteristic is good.

The element which can be axially displaced on the centrifugal drum preferably is a piston slide.

As an alternative, the element which can be axially displaced on the centrifugal drum can be a piston slide surrounding the drum bottom part and/or the centrifugal chamber bottom part on the outer circumference.

Additional advantageous embodiments of the invention are contained in the remaining subclaims.

In the following, the invention will be described in detail by means of an embodiment with reference to the drawing.

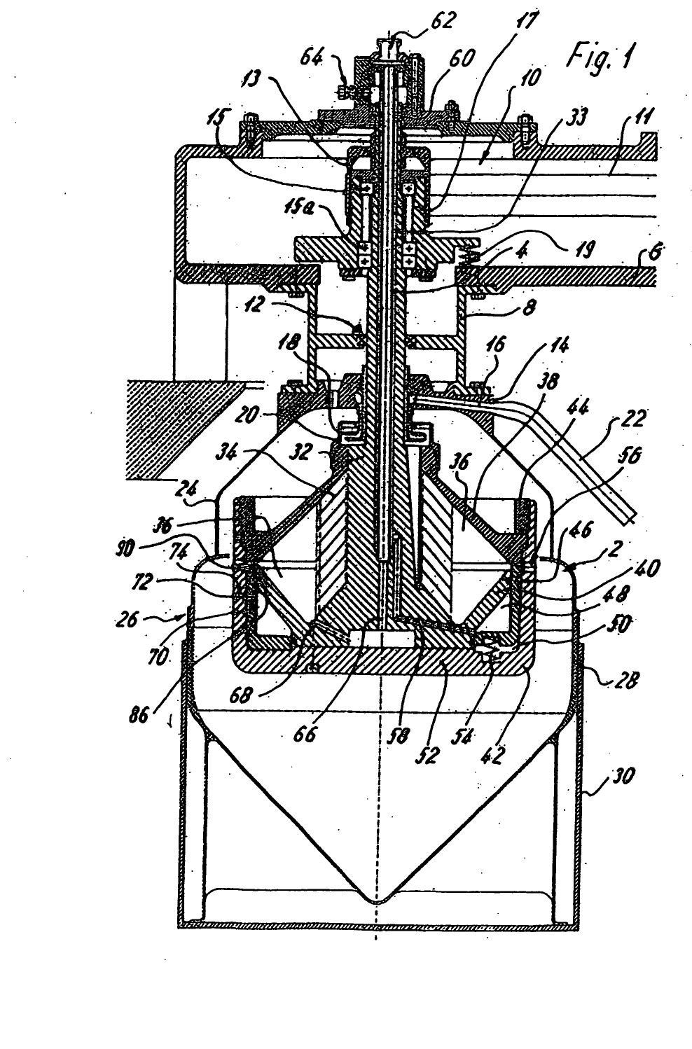

FIG. 1 is a sectional view of a centrifuge according to the invention;

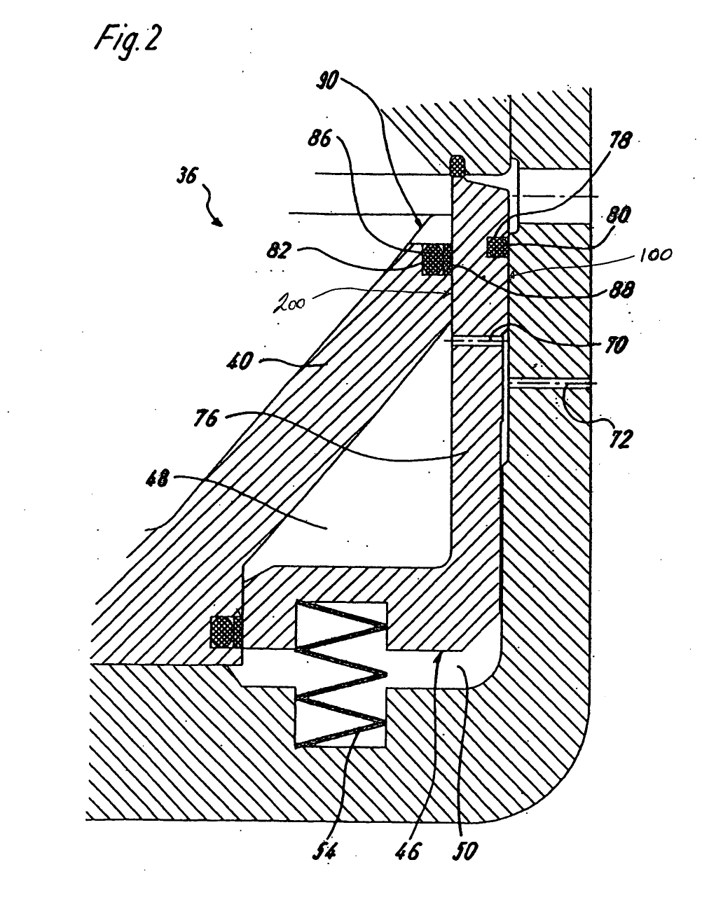

FIG. 2 is a view of a partial area of another centrifuge according to the invention; and

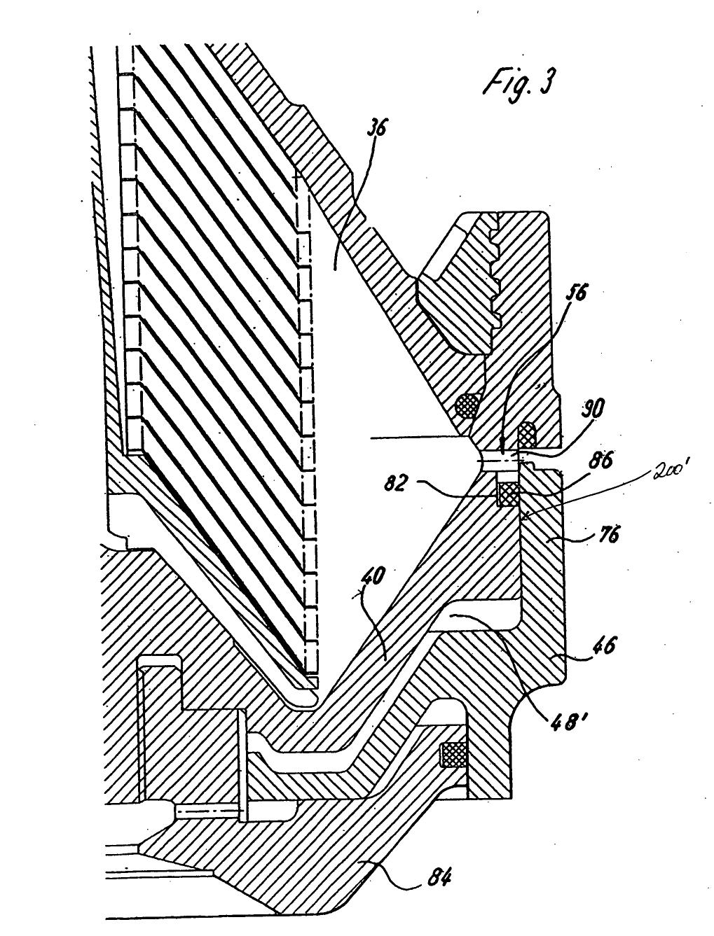

FIG. 3 is a view of a partial area of a third centrifuge according to the invention.

FIG. 1 illustrates a centrifuge which is constructed as a separator and has a rotatable centrifugal drum 2. The centrifugal material or the centrifugal liquid is guided into the centrifugal drum 2 through a central feeding pipe 4.

By way of its feeding pipe 4 and a projection 33 concentrically surrounding the feeding pipe 4 and lengthening the distributor 32 upward from the centrifugal drum 2, the centrifugal drum 2 is rotatably arranged or suspended on the centrifuge frame 6 with its lower frame attachment 8. In this case, a driving belt 11 of the driving section 10 is wrapped around a pot-type pulley 13 which is attached to the projection 33 and takes the latter along with it. The bearings 15 and 15a on the outer circumference of the projection 33 permit rotations of the projection 33 in a ring 17 which surrounds the projection 33 and is supported by way of spring elements 19 on the frame 6.

The lower frame attachment 8 is sealed off with respect to the centrifugal drum 2 by way of a sealing section 12 in the frame attachment 8. A receptacle cover 14 is flanged to the lower end of the frame attachment 8 and is penetrated in the center by the feeding pipe 4. The receptacle cover 14 has an annulus which leads into an essentially radially constructed bore 16 which is used as a discharge duct for a liquid phase from the centrifugal drum 2, which is discharged by means of a peeling disk 18 from a peeling disk chamber 20. The bore 16 leads into a discharge pipe 22.

An upper outer receptacle wall 24 is shaped onto the receptacle cover 14, which receptacle wall 24 surrounds the centrifugal drum 2 in its upper area and serves as an upper end of a of a conical receptacle 26 for receiving solids, the lower section 28 of the receptacle being removable from the centrifuge in the downward direction and standing in a receptacle frame 30.

The actual centrifugal drum 2 has a distributor 32 which surrounds the feeding pipe 4 and has a stack of plates 34 attached to the distributor 32 on the outside. The stack of plates 34 is situated in a centrifugal chamber 36 which conically narrows in the upward and downward directions and is bounded in the upward direction by a conically shaped drum cover 38 and in the downward direction by a conically extending centrifugal chamber bottom part 40 which is shaped to the distributor 32 at the bottom.

The drum cover 38 is inserted into a drum bottom part 42 and is screwed into the drum bottom part 42 by means of a locking ring 44.

A displaceably guided, ring-shaped piston slide 46 with an, in this case, essentially L-shaped wall cross-section is arranged between the centrifugal chamber bottom part 40 and the lower housing wall of the drum bottom part 42, which L-shaped wall cross-section is adjoined by an opening chamber 48 in the upward direction and by a closing chamber 50 in the downward direction. A lower wall of the drum bottom part 42 is used as the lower closing chamber bottom 52. Between the lower wall of the piston slide 46 and the closing chamber bottom 52—thus, in the closing chamber 50—, closing springs 54 may be arranged which hold the piston slide 46 in its closing position in which it closes off the solids outlet openings 56 in the outer wall of the drum bottom part 42 (right part of FIG. 1).

The opening chamber 48 is constructed between the piston slide 46 and the lower wall of the distributor 32 or the centrifugal chamber bottom part 40. The control fluid supply into the opening chamber 48 takes place by way of a control fluid feed 58 in the distributor 32.

The control fluid feed 58, particularly for a control gas, leads into ring-shaped feeding duct 60 surrounding the feeding pipe 4 rotating along, between the inner wall of the distributor 32 and the feeding pipe 4 inserted in the distributor 32. The inner wall of the distributor 32 and the wall of the feeding pipe 4 in this case form a type of “pipe with a double wall”, the actual feeding duct 60 for the control fluid concentrically surrounding the feeding pipe 4 for the centrifugal material.

Above the upper end area of the centrifuge frame 6, an axial connection 62 permits the feeding of the centrifugal material into the feeding pipe 4. A connection 64, which here is oriented radially to the outside, is used for feeding the control fluid—particularly the feeding of sterile control air—into the feeding duct 60 surrounding the feeding tube.

The feeding of the centrifugal material takes place through the connection 62 and the feeding pipe 4 as well as through the axial bore 66 of the distributor 32 and a bore 68 in the centrifugal chamber bottom part 40 here extending essentially radially, into the centrifugal chamber 36. Solids are discharged from the centrifugal chamber 36 through the openings 56; liquid phases are discharged through the peeling disk chamber 20 having the peeling disk 18.

Preferably, a gas, such as control air, as the control fluid is guided through the connection 64 into the feeding duct 60 concentrically surrounding the feeding pipe 4. From there, the control air flows into the control fluid feed 58 and from there into the opening chamber 48. As a result, when the pressure buildup in the opening chamber 48 is correspondingly large, the piston slide 46 is pressed downward against the spring force of the closing springs 54, which opens the solids discharge openings 56 (left section of FIG. 1). In contrast, a lowering of the pressure in the opening chamber 48, because of the spring force of the closing springs 54, results in a displacement of the piston slide 46 in the upward direction, which closes the solids discharge openings 56 again.

The piston slide 46 and the outer wall of the centrifugal drum 2 according to FIG. 1 have passage bores 70, 72 which are in an operative connection, at least the outer passage bore being closable by means of a stopper 74.

The piston slide 46 has a cylindrical section 76 whose outer circumference rests against the inner circumference of the centrifugal drum 2. A surrounding groove 78 is constructed on the outer circumference of the cylindrical section 76. A seal 80, which also surrounds the piston slide, is inserted into this groove 78 and has the purpose of sealing off the gap between the outer circumference of the piston slide 46 and the inner circumference of the centrifugal drum 2.

On the outer circumference of the centrifugal chamber bottom part 40,—see also FIG. 2—a surrounding groove 82 is constructed. According to FIG. 2, two surrounding seals 86, 88 are inserted into this groove 82, which seals 86, 88 have the purpose of separating the product chamber or centrifugal chamber 36 in the centrifugal drum 2 from the control area—here, the opening chamber 48—in that they seal off the gap between the outer circumference of the centrifugal chamber bottom part 40 and the inner circumference of the cylindrical section 76 of the piston slide 46. As an alternative, only a single sealing ring respectively could also be arranged in the groove 82 (not shown here).

The groove 82 is constructed on the outer circumference of the centrifugal chamber bottom part 40 at least in sections axially open in the direction of the centrifugal chamber 36 or toward the centrifugal chamber. However, at preselected angular distances, a radial web 90 of the centrifugal chamber bottom part 40 is in each case also situated on the centrifugal chamber bottom part 40 in the axial direction over the two seals 86, 88 in order to prevent in a simple manner an unintentional falling of the seals 86, 88 out of the groove 82 during movements of the piston slide 46. One or all sealing ring(s) 86, 88 can be constructed as a simple and cost-effective as well as sanitarily advantageous square ring.

Since the groove 82 is situated to be axially largely open toward the centrifugal chamber 36 with the exception of the area of the webs distributed on the circumference, on the one hand, no centrifugal material can deposit in the gap between the centrifugal chamber bottom part 40 and the inside diameter of the piston slide 46 and, on the other hand, can be easily reached by the cleaning fluid during the cleaning. This clearly reduces the tendency to form deposits in the area of the seals 86 and 88.

For the cleaning, a cleaning fluid can easily also be guided through the control fluid paths. By way of the bore 70, it also reaches the closing chamber 50 and the bore 72. Below the groove, additional grooves can be provided in order to accommodate additional seals and in order to further optimize the sealing function (not shown).

A bore can also be constructed in the centrifugal chamber bottom part, which, in a simple manner, permits the feeding of cleaning media (such as, CIP Cleaning-In-Place) into the gap between the centrifugal chamber bottom part and the piston slide (not shown here).

In contrast to FIG. 1, according to FIG. 3, the piston slide 46 on the outer circumference of the drum bottom part 40 shaped onto the distributor is displaceably guided relative to the drum bottom part 40, the centrifugal chamber bottom part 40 and the drum bottom part 42 being combined to one constructional element, and the piston slide 46 enclosing the drum bottom part 40 on its outer circumference. In order to further implement the control functions for operating the piston slide 46, a ring 84 is situated below the piston slide, which ring 84 is screwed to the drum bottom part 40. A chamber for operating the piston slide 46 by means of pressure buildups and reductions in the chamber can be provided between the ring 84 and the piston slide 46 on its underside. As an alternative, a spring support of the piston slide 46 can be implemented on the ring 84 in the manner of the spring support of FIG. 2 (not shown).

In this case, a surrounding groove 82 is again constructed on the outer circumference of the drum bottom part 40, into which groove 82 at least one surrounding seal 86 or sealing ring is inserted. This surrounding seal 86 or sealing ring has the purpose of separating the product chamber or centrifugal chamber 36 in the centrifugal drum 2 from the control area—here, the opening chamber 48′—in that it seals off the gap between the outer circumference of the centrifugal chamber bottom part 40 and the inner circumference of the cylindrical section 76 of the piston slide 46. This groove 82 is also opened toward the centrifugal chamber, again with the exception of a few webs 90 distributed on the circumference in order to avoid deposits in the gap and, on the other hand, as a result of the webs, ensure a good hold of the seal while maintaining the sanitary advantages.

Reference Numbers
Centrifugal drum 2
feeding pipe 4
centrifuge frame 6
frame attachment 8
driving section 10
driving belt 11
sealing section 12
pulley 13
receptacle cover 14
bearing 15, 15a
bore 16
ring 17
peeling disk 18
spring elements 19
peeling disk chamber 20
discharge pipe 22
outer receptacle wall 24
receptacle 26
lower receptacle section 28
receptacle frame 30
distributor 32
projection 33
stack of plates 34
centrifugal chamber 36
drum cover 38
centrifugal chamber bottom part 40
drum bottom part 42
locking ring 44
piston slide 46
opening chamber 48, 48′
closing chamber 50
closing chamber bottom 52
closing springs 54
solids discharge openings 56
control fluid feed 58
feeding duct 60
axial connection 62
radial connection 64
axial bore 66
radial bore 68
passage bores 70, 72
stopper 74
cylindrical section 76
groove 78
seal 80
grooves 82
ring 84
seals 86, 88
web 90

1-9. (canceled)

10. A centrifuge, comprising:
a centrifugal drum including a centrifugal chamber and a centrifugal chamber bottom part displaceable relative to the centrifugal drum;
a piston slide axially displaceably arranged one or more of in and on the centrifugal drum;
at least one seal arranged in a surrounding groove on an outer circumference of the centrifugal drum bottom part, the at least one seal arranged between the piston slide and the outer circumference of the centrifugal chamber bottom part to seal off a gap between the piston slide and the centrifugal chamber bottom part; and
the groove, into which the at least one seal is inserted, is configured to be constructed at least in sections and axially open toward the centrifugal chamber such that the at least one seal is situated to be open at least in sections toward the centrifugal chamber.

11. The centrifuge according to claim 10, wherein the groove is axially open except for webs.

12. The centrifuge according to claim 11, wherein, at preselected angular distances, one of the webs is shaped onto the centrifugal chamber bottom part, which secures the at least one seal against falling out of the groove in an axial direction.

13. The centrifuge according to claim 10, wherein the at least one seal includes a plurality of seals inserted in the at least one groove.

14. The centrifuge according to claim 12, wherein the piston slide surrounds at least one of the centrifugal drum bottom part and the centrifugal chamber bottom part on the outer circumference.

15. The centrifuge according to claim 10, wherein at least one seal is constructed as square ring.

16. The centrifuge according the claim 10, wherein the centrifugal drum bottom part is combined with a drum bottom part to form a unitary constructional element.
